(19) United States
(12) Patent Application Publication
(10) Pub. No.: US 2005/0230547 A1
(43) Pub. Date: Oct. 20, 2005

(54) Aircraft drainmast assembly

(76) Inventors: Michael J. Giamati, Akron, OH (US); Charles A. Lee, Akron, OH (US); Terry L. Sluss, Louisville, OH (US)

Correspondence Address: Cynthia S. Murphy;RENNER, OTTO, BOISSELLE & SKLAR, LLP, Nineteenth Floor, 1621 Euclid Avenue, Cleveland, OH, 44115, US

(21) Appl. No.: 11/042,244

(22) Filed: Jan. 25, 2005

Related U.S. Application Data
(60) Provisional application No. 60/539,415, filed on Jan. 26, 2004.

(51) Int. Cl. B64C 1/00

(52) U.S. Cl. 244/129.1

(57) ABSTRACT

A drainmast assembly (10) for ejecting gray water from the onboard potable water system of an aircraft. The assembly (10) includes an interface (14) mounted on the fuselage of the aircraft and a drainmast (16) including a fairing (90) aligned with and attached to the interface (14). The interface (14) includes a pipe (46) having an outlet nipple (48) which is pivotally connected to an inlet portion (146) of the draintube (94). In this manner, the draintube (94) can rotate relative to the interface (14) should the fairing (90) be unintentionally hit by a baggage vehicle and shoved out of alignment with the interface (14).

### RELATED APPLICATIONS

This application claims priority under 35 U.S.C. § 119 (e) to U.S. Provisional Patent Application No. 60/539,415 filed on Jan. 26,2004. The entire disclosure of this provisional application is hereby incorporated by reference.

### FIELD OF THE INVENTION

The present invention relates generally to an aircraft drainmast assembly and, more particularly, to a drainmast assembly for ejecting potable waste water (i.e., gray water) from an onboard potable water system of an aircraft.

### BACKGROUND OF THE INVENTION

A drainmast assembly is used to eject gray water from an aircraft. A typical drainmast includes a fairing attached to the fuselage of the aircraft and a draintube extending through the fairing. The draintube usually includes an inner pipe having an inlet portion which interfaces with the onboard potable water system and an outlet portion from which this water is ejected. To prevent water from freezing as it passes through the pipe, and/or just after it is ejected therefrom, a draintube can incorporate one or more heaters, temperature-sensing instrumentation to coordinate normal and emergency control of the heater(s), and electrical lines leading to/from the heater(s) and the instrumentation.

### SUMMARY OF THE INVENTION

The present invention provides a drainmast assembly which protects the aircraft-drainmast interface should the drainmast be unintentionally struck (e.g., by a baggage cart) when the aircraft is grounded. More particularly, the present invention provides a drainmast assembly comprising an interface mounted to the fuselage and a drainmast having a fairing aligned with the interface and attached thereto. The interface includes a pipe having an inlet portion connected to the onboard potable water system and an outlet portion pivotally connected to an inlet portion of the draintube. In this manner, the draintube can rotate about the interface pipe upon movement of the fairing out of alignment with the interface.

The present invention also provides a draintube design wherein heat output is properly and predictably directed to inner/outer outlet areas. More particularly, the present invention provides an inner outlet heater, an outer outlet heater, and a heater-separating sleeve positioned therebetween. The heater-separating sleeve acts as a thermal barrier between the outlet heaters, and also preferably pushes the inner outlet heater radially inward (towards the inner pipe) and pushes the outer outlet heater radially outward (towards the socket). Preferably, the heater-separating sleeve has a high coefficient of thermal expansion whereby it expands at high heater temperatures and/or is surrounded by an outlet socket which places it in a state of compression.

The present invention additionally provides an outlet heating arrangement which allows the endcap area and the inner pipe area to be heated at different power levels. More particularly, the present invention provides a drain tube wherein an outer outlet heater outputs at least two times more heat than the inner outlet heater. In this manner, the inner pipe area can be moderately heated to prevent freezing of water therein and the endcap area can be aggressively heated to prevent ice from plugging the drainmast discharge.

The present invention also provides a heater layout which can improve draintube reliability and life expectancy. More particularly, the present invention provides a draintube wherein a central heater, an inner outlet heater, and/or an outer outlet heater are formed from a single heater strip. The heating strip comprises a flexible film substrate and heating elements printed or etched thereon, preferably in a single circuit. The film substrate has at least one tail section that is wrapped around the outlet portion of the pipe to form an outlet heater and a ribbon section that is wrapped (e.g., spirally coiled) around the central portion of the pipe to form the central heater.

The present invention additionally provides a heater construction that allows a strip heater to be properly positioned on the pipe of the draintube assembly. More particularly, the present invention provides a draintube wherein the strip heater includes a ribbon section that is spirally wrapped around. a portion of the pipe and is secured thereto by a hot melt adhesive. During assembly of the draintube, the hot melt adhesive is untacky at room temperature whereby the ribbon section can be shifted and repositioned to obtain a desired positioning. Once the desired positioning has been achieved, a heat-applying step (e.g., an oven cure) can be performed to bond the ribbon section permanently in place relative to the inner pipe of the draintube.

The present invention also provides a draintube wherein temperature-sensing instrumentation is located close the drainmast discharge to thereby more closely track outside environmental conditions. More particularly, the present invention provides temperature-sensing instrumentation sealed and potted within a radially inner wall of an outlet socket. The outlet socket can have a clamshell construction comprising two halves which are mechanically fastened together.

These and other features of the invention are fully described and particularly pointed out in the claims. The following descriptive annexed drawings set forth in detail a certain illustrative embodiment of the invention, this embodiment being indicative of but one of the various ways in which the principles of the invention may be employed.

### DRAWINGS

FIG. 1 is a schematic view of a drainmast assembly according to the present invention installed on an aircraft.

FIG. 2 is an exploded side view of the components of the drainmast assembly, these components including an interface and a drainmast.

FIGS. 3A-3C are top, side, and bottom views, respectively, of the interface.

FIGS. 3D and 3E are sectional views of towers of the interface as seen along line 3D-3D and line 3E-3E, respectively, in FIG. 3A.

FIG. 4A is a plan view of a heater for the interface, the heater being shown isolated from the rest of the interface and in a flat pre-assembly condition.

FIG. 4B is a side sectional view of the interface heater.

FIG. 4C is a close-up view of a portion of the heater.

FIGS. 5A-5D are top, fore, side, and aft views, respectively, of the drainmast.

FIG. 5E is a sectional view as seen along line 5E-5E in FIG. 5D.

FIG. 5F is a sectional view as seen along line 5F-5F in FIG. 5E.

FIG. 6 is a side view, partly in section, of the interface and the drainmast installed on a fuselage mounting surface of an aircraft.

FIGS. 7A-7D are top, fore, side, and aft views, respectively, of the draintube isolated from the fairing.

FIG. 7E is a sectional view as seen along line 7E-7E in FIG. 7A.

FIG. 7F and 7G are sectional views as seen along line 7F-7F and line 7G-7G, respectively, in FIG. 7C.

FIG. 7H is a sectional view as seen along line 7H-7H in FIG. 7D.

FIG. 8A is a plan view of an inlet heater for the draintube, the inlet heater being shown isolated from the rest of the interface and in a flat pre-assembly condition.

FIG. 8B is a side sectional view of the draintube's inlet heater.

FIG. 8C is a close-up view of a portion of the draintube's inlet heater.

FIG. 9A is a plan view of a strip used to form a central heater and outlet heaters for the draintube, the strip being shown in a flat, unassembled condition.

FIG. 9B is a side sectional view of an elongated ribbon section of the heater strip.

FIG. 9C is a side sectional view of a tail section of the heater strip.

FIG. 9D is a side sectional view of another tail section of the heater strip.

FIG. 9E is a close-up view of a portion of the heater strip.

FIG. 9F is a plan view of the ribbon section of the heater strip wrapped around a central portion of an inner pipe of the draintube.

FIGS. 10A and 10B are side and front views, respectively, of a first half of an outlet socket for the draintube.

FIG. 10C is a sectional view as seen along line 10C-10C in FIG. 10A.

FIGS. 10D and 10E are auxiliaryviews of the first socket half as seen along lines 10D-10D and 10E-10E, respectively, in FIG. 10B.

FIGS. 10F, 10G, and 10H are side, top and front views, respectively, of the second half of the outlet socket.

### DETAILED DESCRIPTION

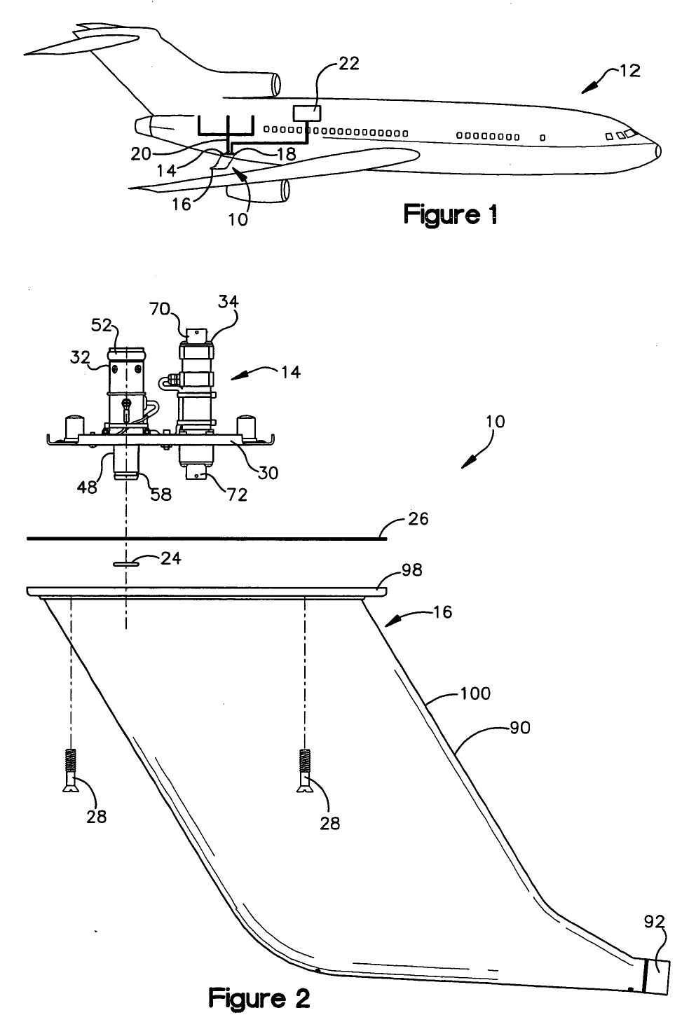

Referring now to the drawings in detail, and initially to FIG. 1, a drainmast assembly 10 according to the present invention is shown installed on an aircraft 12. The drainmast assembly 10 comprises an interface 14 and a drainmast 16. The interface 14 is permanently fixed to a mounting surface 18 of the aircraft's fuselage and is connected to an onboard plumbing outlet 20 and an onboard electrical source/control 22. The drainmast 16 is mounted to the interface 14 and thereby interfaced with the aircraft's plumbing outlet 20 and electrical source/control 22.

Referring now to FIG. 2, the drainmast assembly 10 is shown in more detail. In addition to the interface 14 and the drainmast 16, the assembly 10 can also include an O-ring 24 and a gasket 26. When the drainmast assembly 10 is installed on the aircraft 12, the O-ring 24 is seated within a groove in a plumbing portion of the interface 14 (namely a groove 58 in a nipple 48, introduced below) and the gasket 26 is sandwiched between the aircraft fuselage mounting surface 18 and a flange of the drainmast 16 (namely a fairing flange 98, introduced below). The assembly 10 can further comprise fasteners 28 that are used to secure the drainmast 16 to the interface 14 and to the fuselage 18.

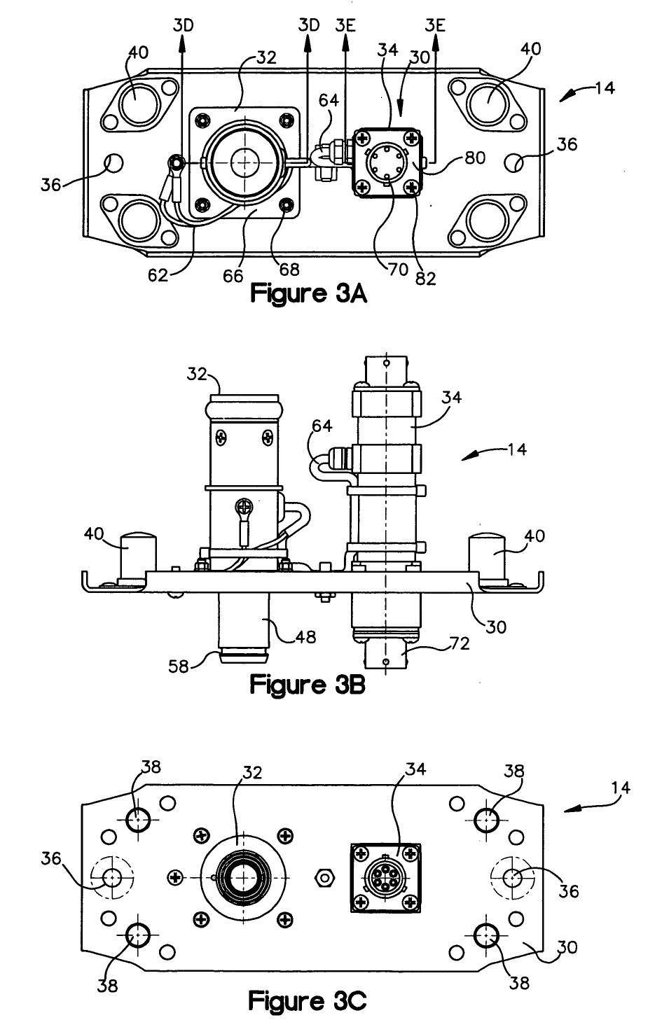

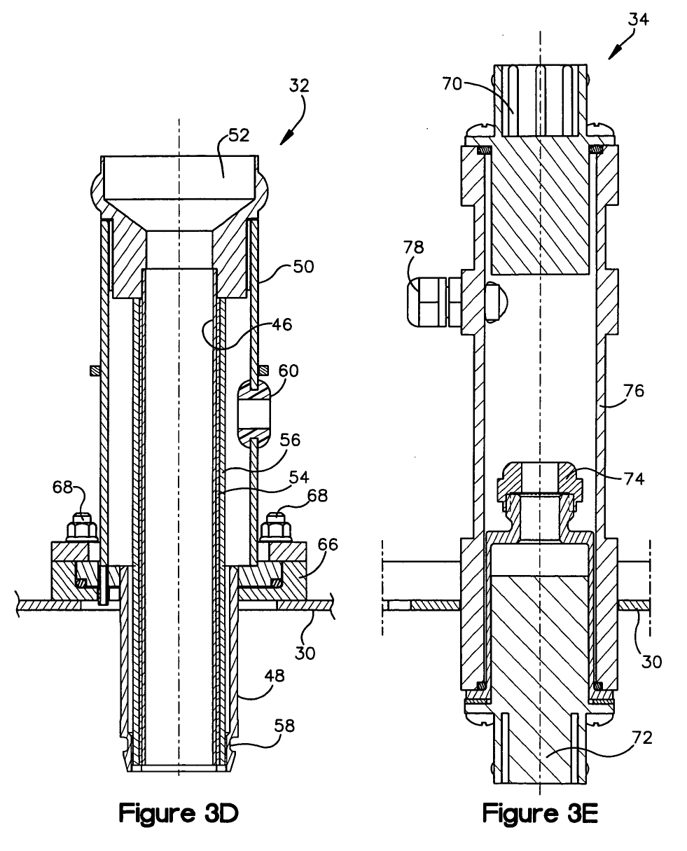

Referring now to FIGS. 3A-3C, the interface 14 is shown isolated from the rest of the drainmast assembly 10. The interface 14 comprises a mounting plate 30, a plumbing tower 32, and an electrical tower 34. The mounting plate 30 includes fore and aft openings 36, and also four corner openings 38 covered by sealed nutplates 40. The plumbing tower 32 and the electrical tower 34 are secured to, and extend through, the mounting plate 30.

As is best seen by referring additionally to FIG. 3D, the plumbing tower 32 comprises an interface pipe 46, a nipple 48, and a housing 50. The pipe 46 has a fitting 52 on its upper inlet portion for connection to the aircraft plumbing outlet 20 and can be surrounded by a heater 54 and an insulating sleeve 56. The nipple 48 surrounds a bottom outlet portion of the pipe 46 which extends through and below the mounting plate 30 and includes a groove 58 for the O-ring 24. The housing 50 surrounds the upper portion of the pipe 46 and includes a grommet 60 through which electrical wires 62 and 64 enter/exit the tower 32. (See FIGS. 3A and 3B.) A mounting flange 66 surrounds the housing 50 and the nipple 48, and it secures the tower 32 to the mounting plate 30 via fasteners 68.

As is best seen by referring additionally to FIG. 3E, the electrical tower 34 comprises a top electrical connector 70 for connection to the onboard electrical source/control 22, a bottom electrical connector 72 for connection to the drainmast 16, and an adapter 74 therebetween. A housing 76 can surround these components and can include a clamp 78 for connection of the heater wire 64 from the plumbing tower 32. (See FIGS. 3A and 3B.)

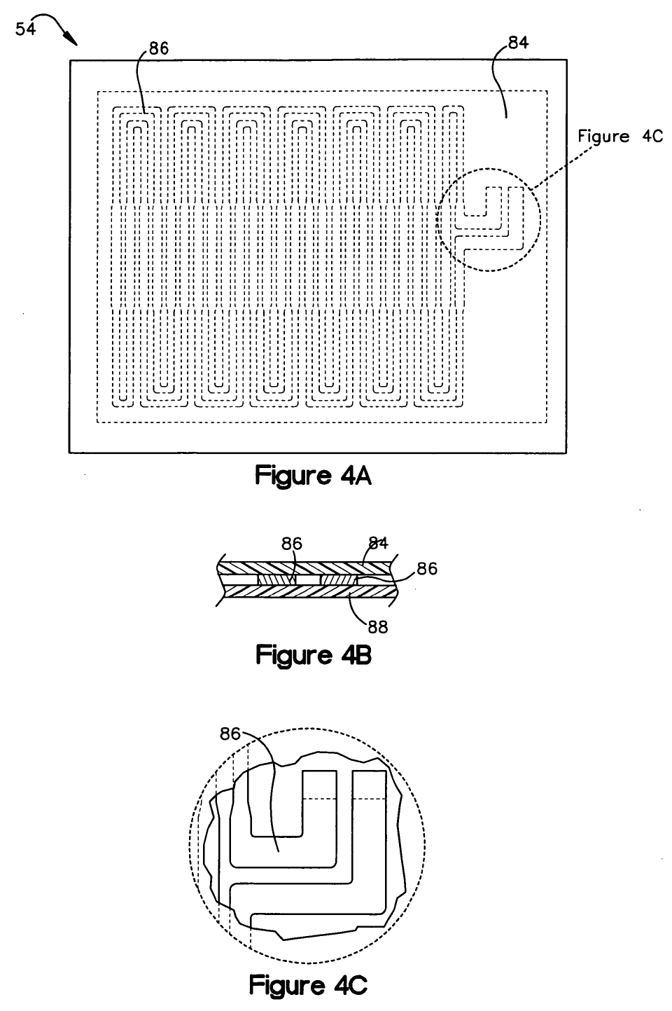

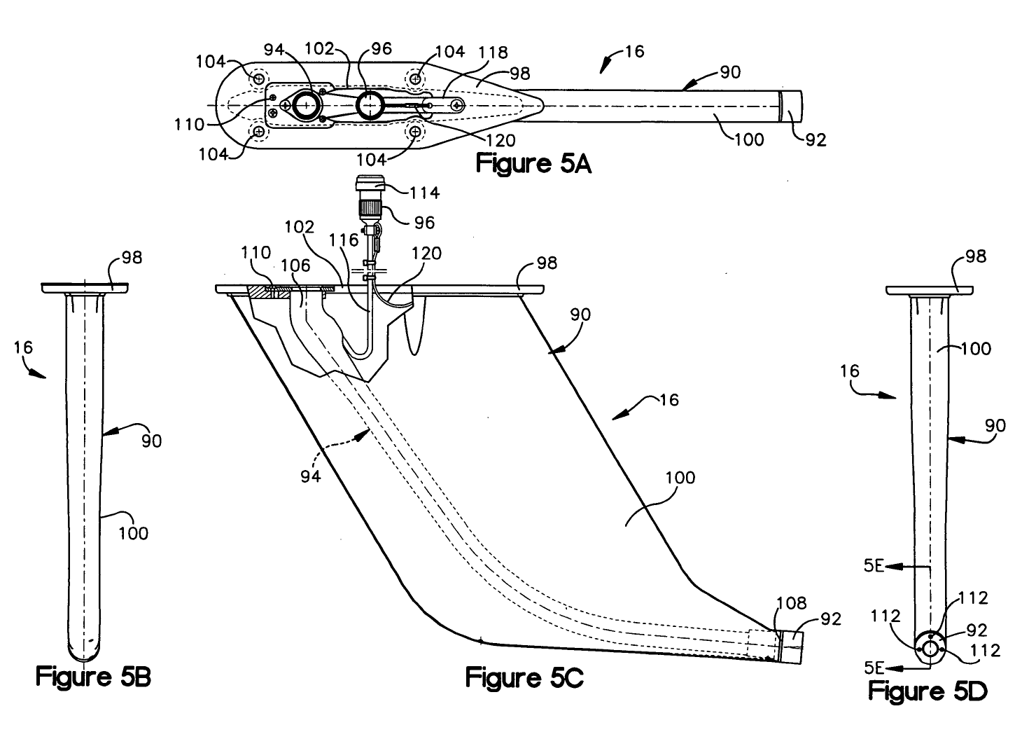

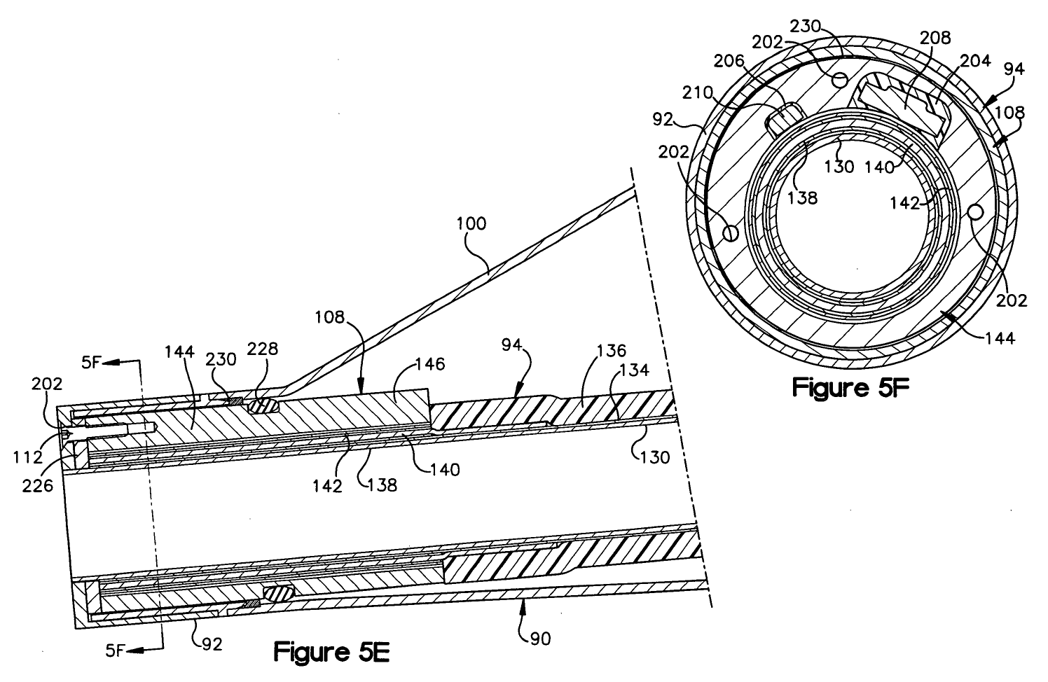

As is best seen by referring additionally to FIG. 4A, the interface heater 54 comprises a thin (e.g., 0.10 mm or less) substrate film 84 having heating elements 86 printed or etched thereon. In the illustrated embodiment, the substrate film 84 has a roughly rectangular shape to surround the cylindrical interface pipe 46. An adhesive coating 88 (e.g., a pressure-sensitive-adhesive) can be applied to the printed/etched side of the substrate film 84 to adhesively secure the heater 54 to the interface pipe 46. (See FIG. 4B.) The heating elements 86 are oriented so that their lead sections are positioned for convenient connection to the wires 64 extending through the grommet 60 in the housing 50. (See FIG. 4C.) Referring now to FIGS. 5A-5D, the drainmast 16 is shown isolated from the rest of the assembly 10. The drainmast 16 comprises a fairing 90, an endcap 92, a draintube 94, and an electrical harness 96. The endcap 92 is attached to the discharge end of the fairing 90, the draintube 94 is positioned within the fairing 90, and the electrical harness is also positioned within the fairing 90. The fairing 90 comprises a mounting flange 98 and a mast 100 sweeping therefrom to the endcap 92. The mounting flange 98 further includes four openings 104 which are alignable with the four corner openings 38 on the mounting plate 30.

The draintube 94 extends through the flange opening 102, through the mast chamber, and into the cylindrical passageway of the endcap 92. (See also FIGS. 5E and 5F.) More specifically, the draintube 94 has an inlet portion 106, which is positioned flush with (or just below) the upper surface of the fairing mounting flange 98, and an outlet portion 108 which extends into the cylindrical passageway in the endcap 92. The inlet portion 106 can be secured to the fairing flange 98 via an attachment plate 110 (and associated fasteners) and the outlet portion 108 can be secured to the endcap 92 via fasteners 112.

The electrical harness 96 comprises a connector 114 for electrical connection with the bottom connector 72 of the interface 14. The electrical connector 114 is moveably positioned within the mast chamber so that it can be lifted through the central opening 102 in the fairing flange 98. As is explained in more detail below, the draintube 94 includes electrical heaters and the associated wires are bundled in a cable 116 which extends between the draintube 94 and the electrical harness 96. The harness 96 can be loosely secured to the fairing 90 by an attachment tab 118 secured to the flange 98 and a landyard 120 loosely extending between the tab 118 and the connector 114.

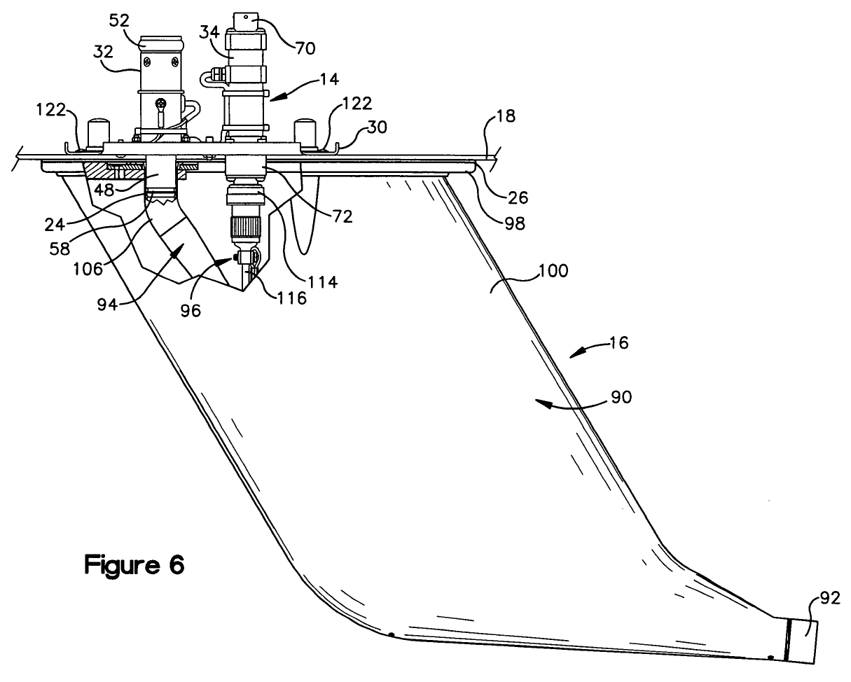

Referring now to FIG. 6, the interface 14 and the drainmast 16 are shown installed on an aircraft 12. In the installation process, the mounting plate 30 of the interface 14 is positioned above the fuselage mounting surface 18 about an appropriate opening. The interface 14 is permanently secured to the fuselage 18 by fasteners 122 which extend through the fore/aft holes 36 on the mounting plate 30. Although not visible in the illustrated view, the fuselage mounting surface 18 includes holes which align with the corner holes 38 of the interface mounting plate 30.

After the interface 14 is permanently mounted to the aircraft 12, the drainmast 16 is held adjacent the mounted interface 14 to begin the drainmast mounting steps. The electrical connector 114 of the harness 96 is lifted above the fairing 90 and mated with the bottom electrical connector 72 of the interface tower 34. The O-ring 24 is placed within the groove 58 of the nipple 48 and the gasket 26 is positioned for sandwiching between the fuselage mounting surface 18 and the fairing flange 98. The drainmast 16 is then aligned with the interface 14 so that the nipple 48 is aligned with the draintube inlet 106 and so that the fairing flange openings 104 are aligned with the corner openings 38 on the interface plate 30 (and the corresponding four openings in the fuselage 18). The drainmast 16 is then slid up onto the nipple 48 and secured to the interface/fuselage with the four fasteners 28 (not visible in FIG. 6, but shown in FIG. 2) which extend upwardly through the fairing flange openings 104, the openings in the fuselage, the interface openings 38 and into the sealed nutplates 40. Thus, the illustrated drainmast 16 can be completely installed to the aircraft 12 from outside of the fuselage.

The drainmast-interface arrangement (e.g., the slip-fit nipple connection and the slack electrical cable 100) of the assembly 10 helps to protect the interface 14 should the drainmast 16 be unintentionally struck (e.g., by a baggage cart) when the aircraft 12 is grounded. Specifically, should the fairing 90 be forced out of alignment with the interface 14, the draintube 94 can pivot about the interface nipple 48 and the electrical harness 96 can accommodate this movement without damaging the interface 14. Moreover, especially if the drainmast-interface fasteners 28 are fracturable fasteners, the drainmast 16 itself may also be salvageable for further use after the collision.

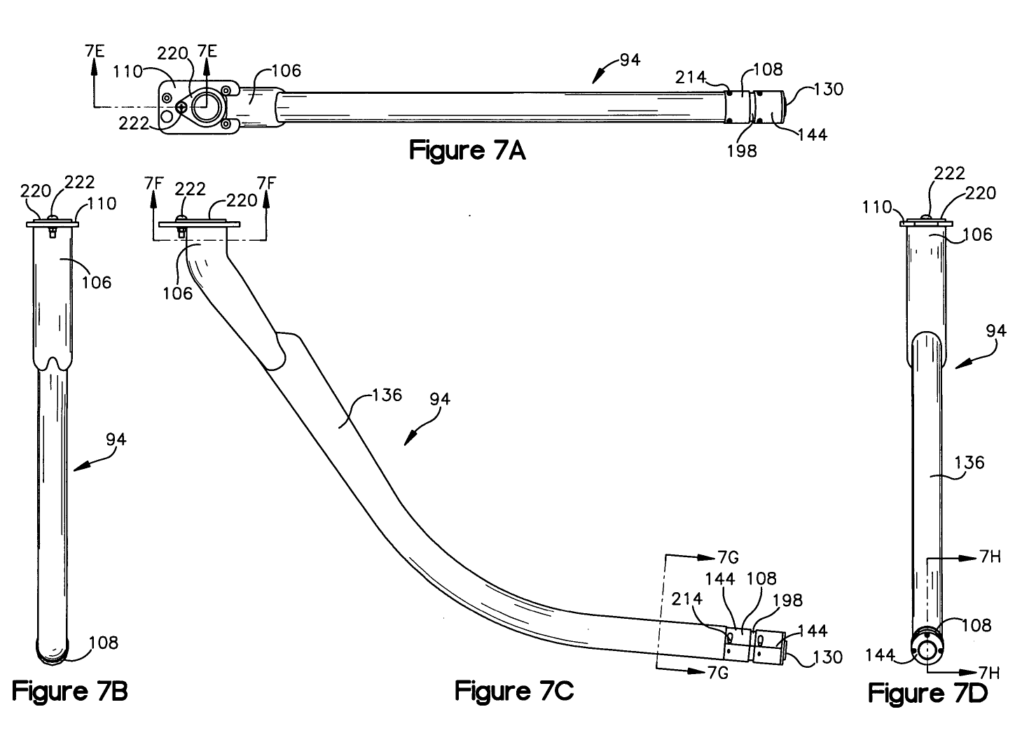

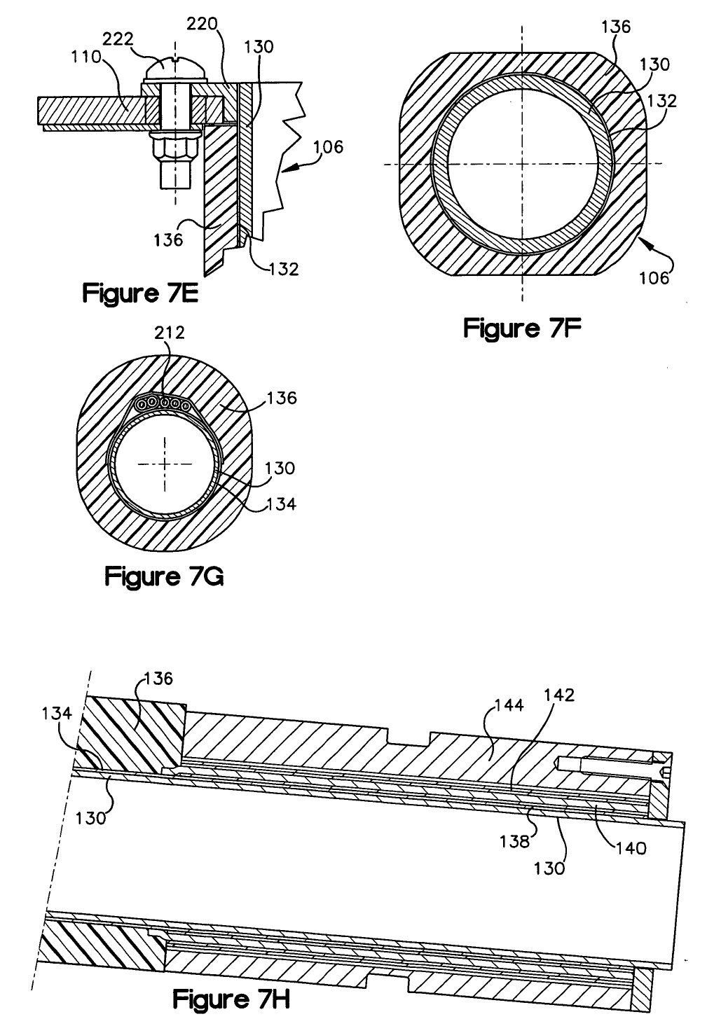

Referring now to FIGS. 7A-7H, the draintube 94 is shown isolated from the rest of the drainmast 16. The draintube 94 comprises an inner pipe 130, an inlet heater 132, a central heater 134, and an insulating sleeve 136. The pipe 130 extends from the inlet to the outlet of the draintube 94 and forms a passageway for the gray water therethrough. The inlet heater 132 surrounds the inlet region of the pipe 130, the central heater 134 surrounds the central region of the pipe 130, and the insulating sleeve 136 surrounds both the inlet heater 132 and the central heater 134.

The draintube 94 further comprises an inner outlet heater 138, a heater-separating sleeve 140, an outer outlet heater 142, and an outlet socket 144, which sequentially surround an outlet portion of the pipe 130. (See particularly FIG. 7H.) This dual-heater and sleeve-socket arrangement allows heat to be properly directed to inner/outer outlet regions of the drainmast 16. Specifically, the heater-separating sleeve 140 acts as a thermal barrier between the outlet heaters 138 and 142. It also preferably acts as a “spring” that is placed in compression by the socket 144 whereby the compressive forces push the inner outlet heater 138 radially inward towards the pipe 130 and push the outer outlet heater 142 radially outward towards the socket 144. Moreover, if the sleeve 140 is silicone as preferred, or any other material having a high coefficient of thermal expansion (i.e., greater than 0.01 mm/° C.), it will expand as heater temperature increase thereby further promoting desired heater contact.

The two distinct outlet heaters 138 and 142 allows the endcap 92 and the inner pipe 130 to be heated at different power levels. For example, the outer outlet heater 142 can have a heat output that is at least about two times the heat output of the inner outlet heater 138. With the illustrated drainmast 16, tunnel testing has shown that fifteen watts on the inner heater 138 and forty watts on the outer heater 142 will maintain the endcap 92 and the draintube 94 at desired temperature conditions.

The heat output differential between the outlet heaters 138 and 142 is advantageous because of the different heating requirements inherent at the outlet of a drainmast design. The inner pipe 130 must be only moderately heated to prevent freezing of relatively warm gray water passing therethrough, while the endcap 92 must be aggressively heated because of the high cooling load placed on it due to forced air convention during flight. If the outer endcap area is not adequately heated, just-ejected gray water can freeze and form a discharge-blocking ice plug over the endcap 92. In the past, the solution was “overheating”inner outlet areas (which can dramatically decrease draintube life expectancy) to avoid ever “underheating” the outer outlet areas.

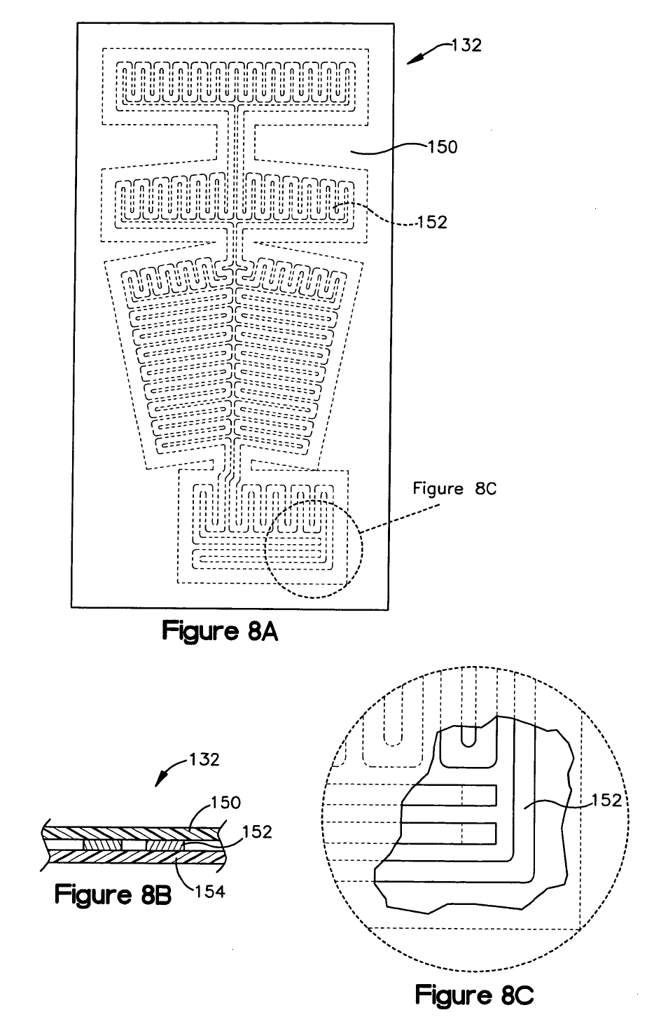

As is best seen by referring additionally to FIG. 8A, the inlet heater 132 is preferably comprised of a thin substrate film 150 (e.g., 0.10 mm or less thick) having foil heating elements 152 printed or etched thereon. The flexible substrate film 150 is shaped to conform tightly to the contours of the pipe 130 in the inlet portion 106 and the heating elements 152 are dimensioned and/or arranged to provide the desired heating pattern. An adhesive coating 154 (e.g., a pressure-sensitive-adhesive) can be applied to the printed/etched side of the substrate film 150 so that the heater 132 can be adhesively attached to the inlet portion of the pipe 130. (See FIG. 8B.) The leads to the heating elements 152 are positioned at a lower part of the substrate film 150 for convenient interconnection with the cable 116 extending to the electrical connector 114. (See FIG. 8C.)

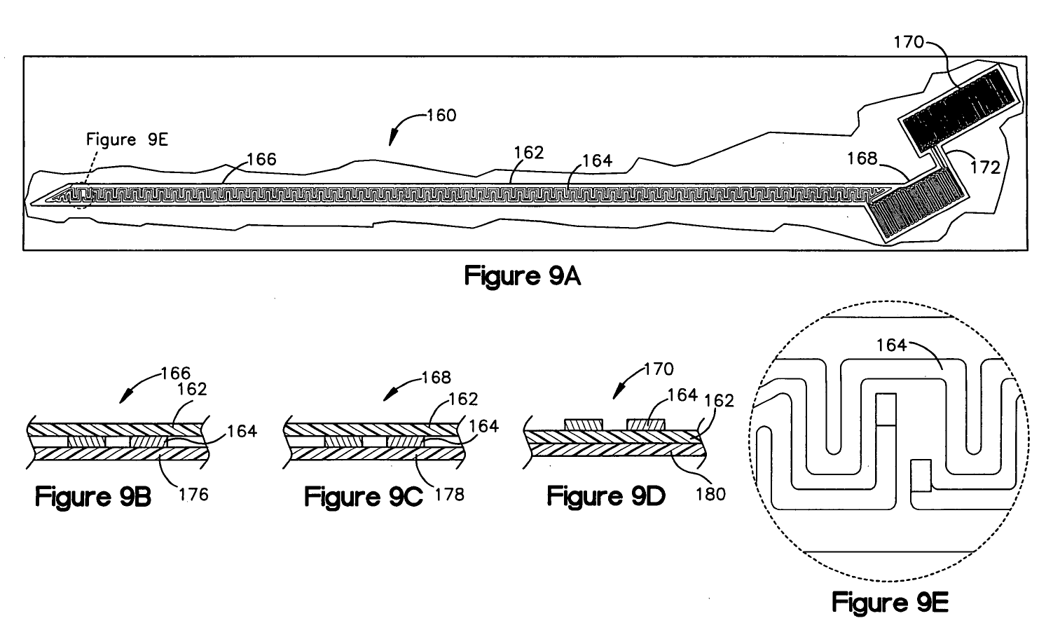

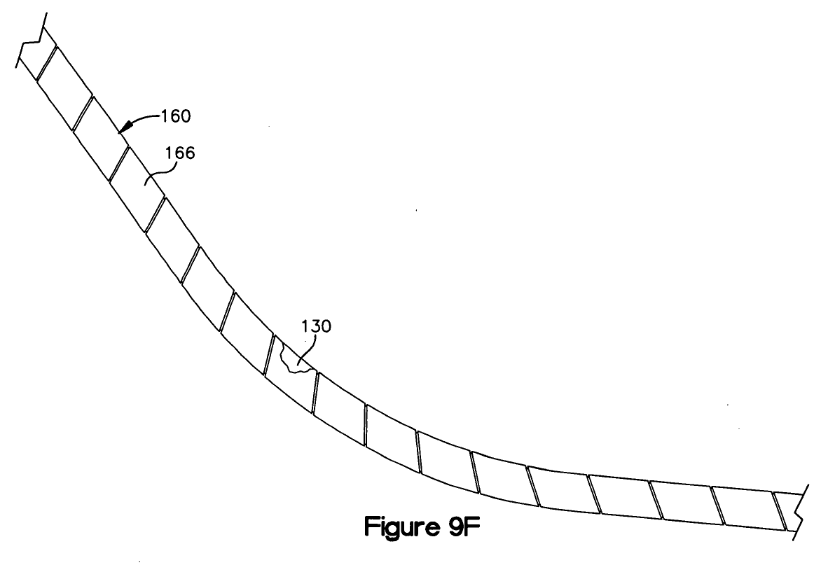

As is best seen by referring additionally to FIG. 9A, the central heater 134, the inner outlet heater 138, and the outer outlet heater 142 are preferably formed from a single strip 160. The strip 160 comprises a thin substrate film 162 (e.g., 0.10 mm or less thick) having the foil heating elements 164 printed or etched thereon. The substrate film 162 has an elongated ribbon section 166 (corresponding to the central heater 134), a tail section 168 (corresponding to the inner outlet heater 138) directly joined to the ribbon section 166, and another tail section 170 (corresponding to the outer outlet heater 142) joined to the tail section 170 by a connecting tab 172. The heating elements 164 on the different sections 166, 168, and 170 can positioned and/or patterned to heat the corresponding different regions of the draintube 94 at different power levels, such as was discussed above in relation to the inner and outer outlet heaters 138 and 142. In the illustrated embodiment, for example, the heating elements 164 are much “denser” on the tail section 170 (Le., the outer outlet heater 142) than on the tail section 168 (i.e., the inner outlet heater 138).

The heater element layout on the strip 160 is preferably accomplished with one heater circuit whereby no separate leads are required for connection to the different heating areas. For example, in the illustrated embodiment, the two leads for the entire strip 160 can be positioned at the “non-tail” end of the ribbon section 166 for convenient interconnection with the cable 116 extending to the electrical connector 114. (See FIG. 9E.)

An adhesive coating 176 can be applied to the etched/printed side of the ribbon section 166, an adhesive coating 178 can be applied to the etched/printed side of the tail section 168, and an adhesive coating 180 can be applied to the. nonetched/nonprinted side of the tail section 170. (See FIGS. 9B-9D.) Preferably, the adhesive coating 176 for the ribbon section 166 comprises a heat-melt adhesive which is not tacky at room temperature. The adhesive coating 178 for the tail section 168 and/or the adhesive coating 180 for the tail section 170 can be pressure-sensitive adhesive coating(s).

To assemble the heaters 132,134, 138, and 142 on the inner pipe 130, the inlet heater 132 can be wrapped around the inlet portion and the tail section 168 of the heater strip 160 can be wrapped around the outlet portion of the pipe 130. If the adhesive coatings 154 and 178 comprise pressure-sensitive adhesive coatings, as preferred, heater-to-pipe attachment can be accomplished at room temperature.

The ribbon section 166 of the heater strip 160 is spirally wrapped around the central portion of the pipe 130. (See FIG. 9F.) If the adhesive coating 176 comprises a hot-melt-adhesive which is not tacky at room temperature, the ribbon section 166 will not “stick” to the pipe 130. This very advantageously allows post-wrapping shifting and repositioning of the coiled ribbon section 166, and even the option of re-doing a poorly executed initial coiling, so that the desired spiral pattern can be obtained. (With a pressure-sensitive-adhesive, for example, such maneuvering would be difficult.) Once the desired spiral pattern of the ribbon section 166 has been reached, it can be temporarily held in place by a piece of tape (not shown) secured to its upper end. A later heat-application step (e.g., an oven cure) can be performed to permanently secure the ribbon section 166 in this position.

As was indicated above, the heater-separating sleeve 140 is positioned between the inner outlet heater 138 and the outer outlet heater 142. Preferably, the sleeve 140 comprises a silicone heat-shrink sleeve which is placed over the two layers of the previously attached tail section 168 (i.e., the inner outlet heater 138) and heat-shrunk thereonto. Thereafter, the tail section 170 of the heater strip 160 (i.e., the outer outlet heater 142) is wrapped around the sleeve 140. If the tail's adhesive coating 180 is a pressure-sensitive adhesive coating, as preferred, heater-to-sleeve attachment can be accomplished at room temperature.

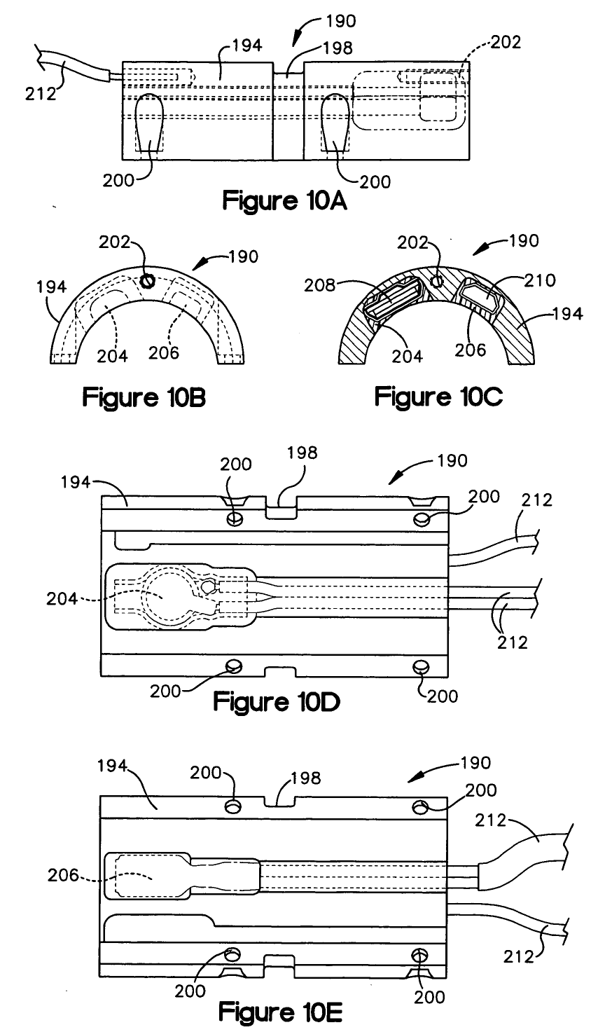

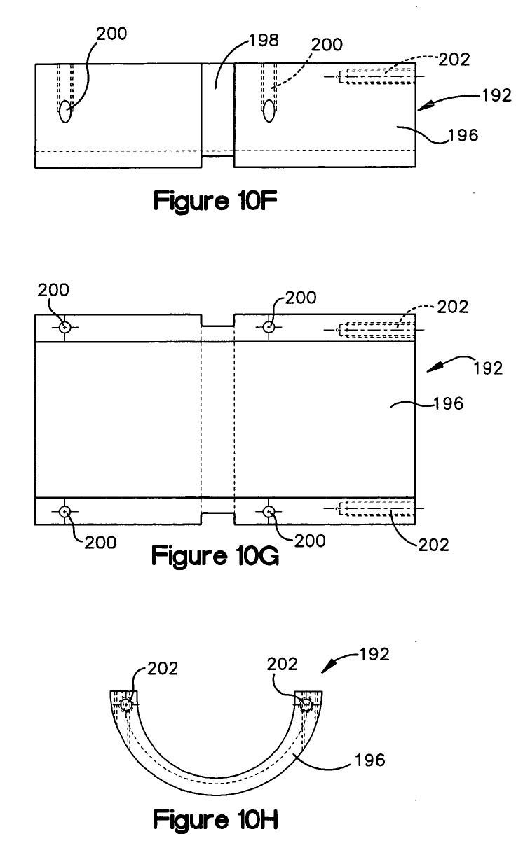

After attachment of the outer outlet heater 142, the outlet socket 144 is placed thereover. As is best seen by referring to FIGS. 10A-10H, the outlet socket 144 preferably has a clam-shell construction with two halves 190 and 192. The first half 190 comprises a semi-cylindrical body 194 and the second half 192 comprises a semi-cylindrical body 196, each body 194/196 having a circumferential groove 198 formed on its radially outer wall. The bodies 194 and 196 also each include tangential openings 200 and bottom axial-extending openings 202.

The first socket half 190 additionally includes pockets 204 and 206 accessible from its radially inner wall. Temperature sensing equipment (e.g., a thermostat 208 and as sensor 210) are potted and sealed within the pockets 204 and 206. Lead wires 212 from the thermostat 208 and sensor 210 extend through channels in the pockets 204 and 206 and beyond the top edge of the bodies 194 and 196. It may be noted that temperature-sensing instrumentation 208/210 can be sealed within the socket 144 prior to its incorporation into the draintube 94. This allows pre-incorporation testing of the instrumentation and consistency/repeatability between similar drainmast units. Also, as best seen by referring briefly back to FIG. 5F, when the socket 144 is incorporated into the draintube 94, the instrumentation 208/210 is advantageously located near the most ice-plugging-susceptible area on the drainmast 16 (i.e., the endcap area). This location provides very meaningful temperature readings to better track environmental conditions just outside the drainmast 16.

When the socket halves 190 and 192 are placed over the outer outlet heater 142, the semi-circular grooves 198 are aligned with each other to form a circumferential groove about the socket 144. The tangential openings 200 are aligned and fasteners 214 are inserted to secure the halves 190 and 192 together. (The fasteners 214 are shown in FIGS. 7A and 7C.) The insulating sleeve 136 can then be molded onto the inlet heater 132 and the central heater 134 to complete the assembly of the draintube 94.

Priming, sizing, and/or smoothing steps may be necessary before/after certain of the above-discussed assembly steps to insure secure, wrinkle-free, and otherwise appropriate compilation of the draintube components. For example, primer may be applied to the inner pipe 130 prior to adhesively attaching the heaters 132 and 38, and primer may be applied to the heater 142 prior to adhesively attaching it to the sleeve 140. Also, clamps may be necessary to maintain the sleeve 140 and/or the outer outlet heater 142 in a cylindrical shape during curing/cooling steps. Further, components might need to be temporarily wrapped with tapes or films (e.g., Mylar tape and/or Kapton tape, which are registered trademarks of E.I.DuPont DeNemours of Delaware) during clamping and curing steps.

Referring now back to the fifth and seventh series of drawings, a teardrop-shaped tab 220 is welded or otherwise attached to the interfacing end of the pipe 130 and is attached, via a fastener 222, to the attachment plate 110. (See FIGS. 5A and 7E.) The outlet socket 144 extends beyond the fairing's discharge end and the inner pipe 130 extends beyond the outlet socket 144. (See FIG. 5E.) The endcap 92 is positioned around the inner pipe 130 and the outlet socket 144 is secured thereto by the fasteners 112 which extend through openings aligned with the axial openings 202 in the socket 144. (FIGS. 5D and 5E.) A plate 226 may be positioned between the endcap 92 and the socket's axial end, an O-ring 228 may be positioned within the groove 198, a moisture sealant 230 may be positioned between the side walls of the endcap 92 and the socket 144, and/or grease may be appropriately applied between components. (See FIG. 5E.)

One may now appreciate that the present invention provides a drainmast assembly 10, an interface 14, a drainmast 16, and/or a draintube 94 which provides many advantages over earlier designs. Although the invention has been shown and described with respect to a certain preferred embodiment, it is obvious that equivalent and obvious alterations and modifications will occur to others skilled in the art upon the reading and understanding of this specification. The present invention includes all such alterations and modifications and is limited only by the scope of the following claims.

1. A drainmast assembly for ejecting gray water from an onboard potable water system of an aircraft, said assembly comprising:
an interface mounted on fuselage of the aircraft and including an interface pipe having an outlet portion and an inlet portion connected to the onboard potable water system, and
a drainmast including a fairing aligned with and attached to the interface, and a draintube having an inlet portion and an outlet portion through which gray water is ejected;
wherein the outlet portion of the interface pipe is pivotally connected to the inlet portion of the draintube thereby allowing the draintube to rotate about the interface pipe upon movement of the fairing out of alignment with the interface.

2. A drainmast assembly as set forth in claim 1, wherein the outlet portion of the interface pipe is surrounded by a nipple which slip fits into the inlet portion of the draintube.

3. A drainmast assembly as set forth in claim 1, wherein the drainmast is installable to the interface from outside the fuselage of the aircraft.

4. A draintube having an inlet portion which interfaces with an onboard potable water system of an aircraft and an outlet portion through which gray water is ejected; said draintube comprising:
a pipe which extends from the inlet portion to the outlet portion and forms a passageway for the gray water;
an inner outlet heater surrounding an outlet portion of the pipe,
a heater-separating sleeve surrounding the inner outlet heater, and
an outer outlet heater surrounding the heater-separating sleeve;
wherein the heater-separating sleeve pushes the inner outlet heater radially inward and pushes the outer outlet heater radially outward.

5. A draintube as set forth in claim 4, wherein the heater-separating sleeve has a high coefficient of thermal expansion whereby it expands at high heater temperatures to thereby further push the inner outlet heater radially inward and push the outer outlet heater radially outward.

6. A draintube as set forth in claim 5, further comprising an outlet socket surrounding the heater-separating sleeve and wherein the outlet socket compresses the heater-separating sleeve whereby compressive forces push the inner outlet heater radially inward and push the outer outlet heater radially outward.

7. A draintube as set forth in claim 6, wherein the outlet socket has a clamshell construction comprising two halves which are positioned around the outer outlet heater and mechanically fastened together.

8. A draintube as set forth in claim 4, wherein the inner outlet heater and the outer outlet heater are formed from a single heater strip comprising a film substrate on which heating elements are formed, the heater strip having one tail section that is wrapped around the outlet section of the pipe to form the inner outlet heater, and another tail section that is wrapped the heater-separating sleeve to form the outer outlet heater.

9. A draintube as set forth in claim 8, wherein the heating elements on both of the tail sections are part of a single heating circuit.

10. A draintube having an inlet portion which interfaces with an onboard potable water system of an aircraft and an outlet portion through which gray water is ejected; said draintube comprising:
a pipe which extends from the inlet portion to the outlet portion and forms a passageway for the gray water;
an inner outlet heater surrounding an outlet portion of the pipe,
a heater-separating sleeve surrounding the inner outlet heater, and
an outer outlet heater surrounding the heater-separating sleeve;
wherein the heater-separating sleeve acts as a thermal barrier between the inner outlet heater and the outer outlet heater; and
wherein the outer outlet heater provides at least two times more heat output than the inner outlet heater.

11. A draintube as set forth in claim 10, wherein the inner outlet heater and the outer outlet heater are formed from a single heater strip comprising a film substrate on which heating elements are formed, the heater strip having one tail section that is wrapped around the outlet section of the pipe to form the inner outlet heater, and another tail section that is wrapped the heater-separating sleeve to form the outer outlet heater.

12. A draintube having an inlet portion which interfaces with an onboard potable water system of an aircraft and an outlet portion through which gray water is ejected; said draintube comprising:
a pipe which extends from the inlet portion to the outlet portion and forms a passageway for the gray water,
a central heater surrounding a central portion of the pipe, and
an outlet heater surrounding an outlet portion of the pipe;
wherein the central heater and the outlet heater are formed from a single heater strip comprising a film substrate on which heating elements are formed; and
wherein the film substrate has a tail section that is wrapped around the outlet portion of the pipe to form the outlet heater and a ribbon section that is spirally wrapped around the central portion of the pipe to form the central heater.

13. A draintube having an inlet portion which interfaces with an onboard potable water system of an aircraft and an outlet portion through which gray water is ejected; said draintube comprising:
a pipe which extends from the inlet portion of the outlet portion and forms a passageway for the gray water; and
a heater strip comprising a film substrate on which heating elements are formed and including a ribbon section that is spirally wrapped around a portion of the pipe and that is secured thereto by a hot melt adhesive.

14. A method of making the draintube set forth in claim 13, said method comprising the steps of:
applying a hot melt adhesive that is untacky at room temperature to the ribbon section;
spirally wrapping the ribbon section around the central portion of the pipe;
shifting and repositioning the wrapped ribbon section to obtain a desired positioning; and
applying heat to bond the ribbon section in the desired positioning.

15. A draintube having an inlet portion which interfaces with an onboard potable water system of an aircraft and an outlet portion through which gray water is ejected; said draintube comprising:
a pipe which extends from the inlet portion to the outlet portion and forms a passageway for the gray water;
an outlet heater surrounding an outlet portion of the pipe; and
a socket positioned around the outlet heater, the socket including a cylindrical body and temperature-sensing instrumentation sealed and potted in a radially inner wall of the cylindrical body.

16. A draintube as set forth in claim 15, wherein the outlet socket has a clamshell construction comprising two halves which are positioned around the outlet heater and mechanically fastened together.

17. A draintube having an inlet portion which interfaces with an onboard potable water system of an aircraft and an outlet portion through which gray water is ejected; said draintube comprising:
a pipe which extends from the inlet portion to the outlet portion and forms a passageway for the gray water;
a single heater strip having a ribbon section wrapped around a central portion of the pipe to form a central heater, a tail section wrapped around an outlet portion of the pipe to form an inner outlet heater, and another tail section wrapped around the inner outlet heater to form an outer outlet heater;
a heater-separating sleeve which is positioned between the inner outlet heater and the outer outlet heater and which pushes the inner outlet heater radially inward and pushes the outer outlet heater radially outward.

18. A draintube as set forth in claim 17, further comprising an outlet socket having a clamshell construction comprising two halves which are positioned around the outer outlet heater and mechanically fastened together.

19. A draintube as set forth in claim 17, wherein the heating elements on the tail section forming the outer outlet heater are patterned to provide at least two times more heat output than the heating elements on the inner outlet heater.

20. A draintube as set forth in claim 17, wherein the ribbon section is attached to the central portion of the pipe by a hot melt adhesive.
